(19) United States
(12) Patent Application Publication
(10) Pub. No.: US 2003/0191654 A1
(43) Pub. Date: Oct. 9, 2003

(54) Patent product map

(76) Inventors: Kiran D. Panchal, Mumbai (IN); Carl B. Horton, Brookfield, WI (US); Dave Christensen, Harwinton, CT (US); Balusamy Jayakumar, Coimbatore (IN); Vinod Kumar, Secunderabad (IN)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/116,904

(22) Filed: Apr. 5, 2002

(51) Int. Cl. G06F 17/60

(52) U.S. Cl. 705/1

(57) ABSTRACT

A web based computer program for organizing intellectual property information, the program, when executed causing a computer to display a menu of products available for selection and, upon selection of a product, displaying a graphical representation of the product. The graphical representation includes links identifying portions of the selected product to intellectual property information related to the identified portion of the product.

### FIELD OF THE INVENTION

This invention relates to data viewing, and more particularly to tools for viewing intellectual property data on particular products and technologies.

### BACKGROUND OF THE INVENTION

Patents have become more and more important to a business's success, especially in today's global economy. Patents can be viewed as a strong tool to the holder with a right to exclude others from making, using, selling, or importing the patented technology. In some industries, product turnover is fairly rapid. However, core technology, product features, and markets change at a much slower rate. Accordingly, even in fast-moving industries, patents which cover core technology are very valuable for protecting a company's research and development investment for an extended period of time.

Patents can also be valuable as sources of revenue. In 1993, for example, the revenue generated from patents by U.S. companies was estimated to be over $60 billion. Fred Warshofsky, The Patent Wars, John Wiley & Sons, Inc., New York, 1994. It is believed that patent revenues are rising each year.

More and more corporations and individuals are recognizing the value of patents. The number of patents applied for and issued to U.S. companies is increasing every year, especially in fast moving industries such as computer software and biotechnology. Many international companies have also recognized the value of patents. Foreign companies regularly rank among the leaders of issued U.S. patents annually.

However, not all patents are as valuable to the patent owner or patent licensee as others. Some owned or licensed patents provide little or no value to the corporate entity or individual. However, it is difficult to assess the value of patents because of the very few tools available for patent analysis.

In spite of the heightened awareness being given to patents in some quarters, patents remain one of the most underutilized assets in a company's portfolio. This is due, at least in part, to the fact that many of the companies' own business developers, attorneys, and engineers do not know what patents the company owns and what products have patents associated with them. In most instances, the only link between a business's products or technologies and their associated patents are the inventors whose names appear on the issued patent.

While in some instances inventors are intimately involved with business concerns and legal personnel, in today's volatile job market it is very likely that inventors appearing on issued patents will have moved on from the company who owns the patent to other places within just a few years of filing for the patent, often breaking the knowledge link between the company's products or technologies and the availability of patent protection associated therewith.

In addition, sometimes products include multiple technologies that are separately patented, and the groups of inventors associated with the multiple technologies may not interact closely. Therefore, it is unlikely that anyone within the company might know at one time of all the patents associated with a particular product.

Further, even if there is a list of patents associated with a particular product available, it has heretofore been difficult for all but the lawyers to determine just what types of protection are available for the product, as the patents associated with a product may only include one aspect of that product. It is not uncommon to find a product with a list of a dozen or more patents printed thereon, however, it is difficult to discover what aspects of the product are protected by those patents, even for those within the company selling the product.

If company personnel have access to patent numbers associated with their products, it may not be a trivial task under current circumstances to gather each patent and decipher what aspects of the product at issue are associated with the patent. Further, if the company desires to find intellectual property information on a number of products, the information gathering and interpreting problems become exacerbated.

There are various tools for electronically gathering data about a patent portfolio. See, for example, U.S. Pat. Nos. 6,263,314 and 5,991,751, the specifications of which are hereby incorporated by reference.

The present invention is directed to solving, or at least reducing the effects of, or more of the problems stated above.

### SUMMARY OF THE INVENTION

The present invention meets the above-described needs and others. Specifically, the present invention provides a method of providing intellectual property data. The method may include: accessing a graphical representation of a product; accessing intellectual property information related to the product; and displaying the graphical representation of the product with one or more links to the intellectual property information of at least one aspect of the product.

The method may further include providing an indicator associated with each of the one or more links to the intellectual property information, the indicator identifying which portions of the product are associated with each of the one or more intellectual property information links.

According to one aspect, the indicator includes highlighting a portion of the graphical representation of the product associated with the one or more links to the intellectual property information. The highlighting of a portion of the graphical representation of a product may occur in response to placing a cursor over the one or more intellectual property information links.

According to one aspect, the method may further include highlighting another portion of the graphical representation of a product associated with another of the one or more intellectual property information links.

According to one aspect of the invention, the non-highlighted portions of the graphical representation of a product may be transparent.

According to one aspect, the intellectual property information related to the product may include one or more of: patent numbers, patents, patent applications, docketing information, design patent numbers, design patents, patent status, copyright registrations, trade secret information, foreign patent numbers, patent families, patent family status, and business data including sales, costs, etc.

According to one aspect, the links to intellectual property information may include displaying of one or more patent numbers corresponding to issued patents. A summary of the patent corresponding to the one or more patent numbers displayed may be shown in response to placing a cursor over the one or more patent numbers displayed. The issued one or more patents themselves may be displayed in response to clicking on the one ore more patent numbers displayed.

According to one aspect of the invention, the links to intellectual property information include displays of one or more docket numbers corresponding to patent applications. A summary of the patent application corresponding to the one or more docket numbers displayed is shown in response to placing a cursor over the one or more docket numbers displayed.

According to one aspect, the accessing of the graphical representation of the product and the related intellectual property information are accomplished via a connection to an internet or intranet.

According to one aspect, the graphical representation of a product is a computer-display of the product's appearance. The graphical representation may be a three dimensional CAD drawing, or the graphical representation may be a digital photograph.

There is also disclosed an electronic program for organizing intellectual property information, the program, when executed: displaying a menu of products on a computer screen available for selection; and upon selection of a product, displaying a graphical representation of the selected product, the graphical representation including links identifying portions of the selected product to intellectual property information related to the identified portion of the product. According to one aspect, the electronic program is web-based.

The program of may further include displaying a choice of language selections, wherein a selection of a language causes the program to translate and display text in the selected language.

According to one aspect of the program, the links identifying portions of the selected product to intellectual property information related to the product may include links to issued patents or published applications. The issued patents or applications may be United States or foreign publications.

According to one aspect of the program, the links identifying portions of the selected product to intellectual property information related to the product may include links to patent docketing information.

According to one aspect of the program, the identified portions of the product having related intellectual property information may be highlighted.

According to one aspect, the program causes new entries to a docketing program to be automatically retrieved and displayed upon selection of a patent docketing information link. The program may cause the patent docketing information link to be automatically replaced by a patent number when the associated a patent issues.

According to one aspect of the program, there may be included links to competitors' patents and/or expired patents relating to the selected product.

According to one aspect, the program is stored on a retrievable media such as a disk or CD.

There is also disclosed a method of accessing intellectual property data including: selecting a product from a menu of products; viewing a graphical representation of the product selected; placing a cursor at a link on the graphical representation of the product selected, the link being associated with at least a portion of the product and having an indicator to indicate what portion of the product is associated with the link, wherein the link contains intellectual property data; and viewing the intellectual property data associated with the at least a portion of the product. According to this method, the user may click on the link to select it. The menu may be web-based.

According to one aspect, the indicator may include highlighting the at least one portion of the graphical representation of the product while at least some remaining portions of the graphical representation of product are transparent.

According to one aspect, the intellectual property data associated with the at least a portion of the product may include a patent, and clicking on the link may causes an electronic copy of the patent to be displayed.

According to one aspect of the method, there may be included the step of translating text displayed into a selected language.

According to one aspect there is a method of accessing product information including: entering at least a portion of a patent number into a search facility; searching for the at least a portion of a patent number in a database; and accessing a graphical representation of products and related intellectual property information associated with the at least a portion of the patent number entered. According to this aspect the method my further include displaying links to intellectual property information associated with the products found by searching for the at least a portion of the patent number.

According to one aspect there is a method of accessing product information including: entering at least a portion of a patent docket number into a search facility; searching for the at least a portion of a patent docket number in a database; and accessing a graphical representation of products and related intellectual property information associated with the at least a portion of the patent docket number entered.

According to one aspect there is a method of accessing product information including: entering at least a portion of a catalog number into a search facility; searching for the at least a portion of a catalog number in a database; and accessing a graphical representation of products and related intellectual property information associated with the at least a portion of the catalog number entered.

Additional advantages and novel features of the invention will be set forth in the description which follows or may be learned by those skilled in the art through reading these materials or practicing the invention. The advantages of the invention may be achieved through the means recited in the attached claims.

### BRIEF DESCRIPTION OF THE DRAWINGS

The patent or application file contains at least one drawing executed in color. Copies of this patent or patent application publication with color drawings(s) will be provided by the Office upon request and payment of the necessary fee.

The accompanying drawings illustrate preferred aspects of the present invention and are a part of the specification. Together with the following description, the drawings demonstrate and explain the principles of the present invention.

FIG. 1 a display according to one aspect of the present invention.

FIG. 2 is another display according to an aspect of the present invention.

FIG. 3 is another display according to an aspect of the present invention.

FIG. 4 is another display according to an aspect of the present invention.

FIG. 5 is another display according to an aspect of the present invention.

FIG. 6 is another display according to an aspect of the present invention.

FIG. 7 is another display according to an aspect of the present invention.

FIG. 8 is another display according to an aspect of the present invention.

FIG. 9 is another display according to an aspect of the present invention.

FIG. 10 is another display according to an aspect of the present invention.

FIG. 11 is another display according to an aspect of the present invention.

FIG. 12 is another display according to an aspect of the present invention.

Throughout the drawings, identical elements are designated by identical reference numbers.

While the invention is susceptible to various modifications and alternative forms, specific aspects thereof have been shown by way of example in the drawings and are herein described in detail. It should be understood, however, that the description herein of specific aspects is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED ASPECTS

Illustrative aspects of the invention are described below. In the interest of clarity, not all features of an actual implementation are described In developing any such actual aspect, numerous implementation-specific decisions can be made to achieve desired goals, such as compliance with system-related and business-related constraints, that can vary from one implementation to another. Moreover, such a development effort might be time-consuming, but would still be a routine undertaking for those of ordinary skill in the art in light of this disclosure.

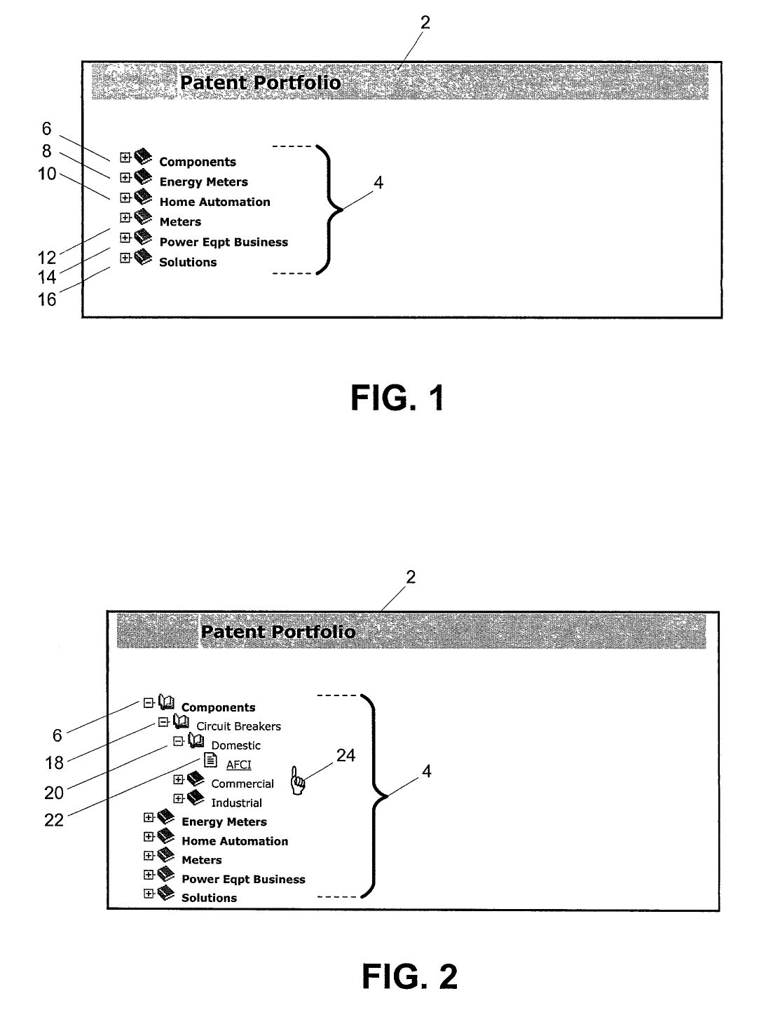

The present invention contemplates, among other things, a method and computer program for accessing, organizing, and presenting intellectual property data. Turning now to the figures, and in particular to FIG. 1, one aspect according to the present invention is disclosed. FIG. 1 illustrates a display (2), for example a window, of an electronic program for organizing and accessing intellectual property data for a number of products or technologies. A “product” may include, but is not limited to: a manufactured good, component, service, method, process, software program, etc. The electronic program may be web-based, but this is not necessarily so. The electronic program may be operable without an internet connection, and it may be operable across all operating systems and platforms. According to the aspect of FIG. 1, a menu, for example expandable menu (4), may be created to display a company's products or technologies. In the aspect shown, there are menus for items such as Components (6), Energy Meters (8), Home Automation (10), Meters (12), Power Equipment Business (14), and Solutions (16). However, it will be understood by those of skill in the art with the benefit of this disclosure that the menu shown is exemplary in nature and can be changed to meet the needs of any business and related intellectual property portfolio.

In addition, before or after display (2) or any other window is presented to a user, the user may be prompted to select a language preference in which the information is to be displayed. Language translation software and web-based translation services are readily available to those of skill in the art having the benefit of this disclosure. Therefore, according the embodiments shown in FIGS. 1-10, a user may have selected “English” as the language of choice, however, it will be understood that language selection may be any other language. In the present embodiments, “English” may simply be the default language choice or it may be specifically requested by the user.

The display (2) shown as FIG. 1 may be created using generally known programming techniques. In addition, if it is desired to create a web-based program, web-building programs and HTML coding that are compatible with, for example, Microsoft Internet Explorer and Netscape, may be used. In some aspects, access to display (2) may be password protected for security concerns, but this is not necessarily so.

As a user wishes to find intellectual property-related information on products included in a company portfolio, she may access display (2) and view the categories listed on expandable menu (4). The categories may include any number of products, components, services, and/or technologies. For example, as shown in FIG. 2, a user may be interested in finding what intellectual property data is related to the Company's Arc Fault Circuit Interrupter (AFCI) product line. In the present case, the user may then expand menu (4) for Components (6) to reveal the submenus of Circuit Breaker (18), followed by Domestic (20), and finally AFCI (22). Menu selection may typically be done by manipulation of any suitable device for making a selection, including, but not limited to: a mouse or other peripheral device to move cursor (24), a keyboard, a touchscreen, and a light pen.

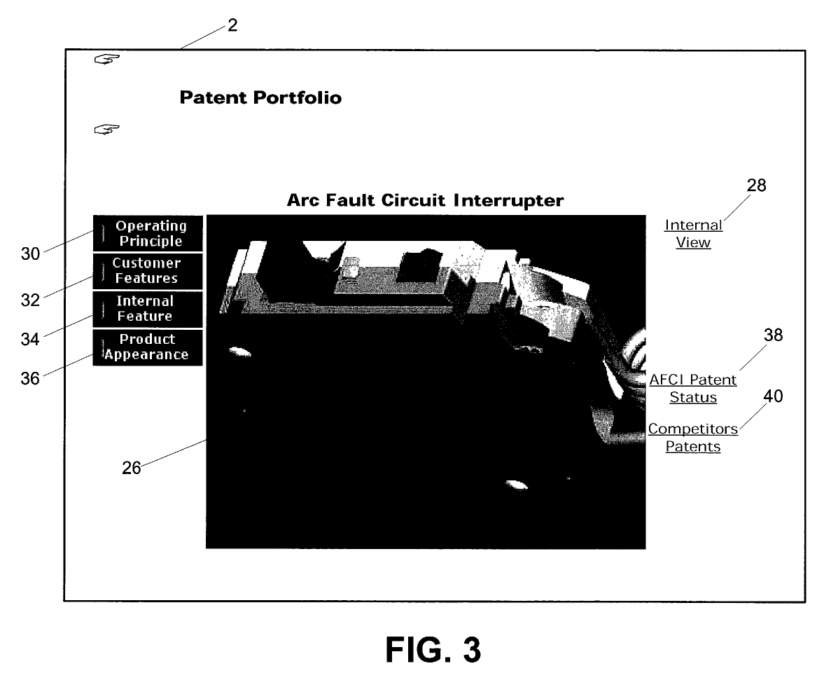

When a user has found the category desired, in the present example AFCI (22), the user may select AFCI (22) to open a new display (2), such as the display shown as FIG. 3. AFCI (22) or any chosen category may include further submenus and categories. According to the present aspect, when a product is selected, a graphical representation of the product selected may be displayed. Graphical representations may include three-dimensional CAD (Computer Aided Drafting) drawings such an AFCI picture (26) shown in FIG. 3, however, other graphical representations may also be accessed by the electronic program. For example a digital photograph may be accessed and displayed to represent the product selected. The introduction of links to display pictures and/or other graphics may be accomplished by one of skill in the art with the benefit of this disclosure.

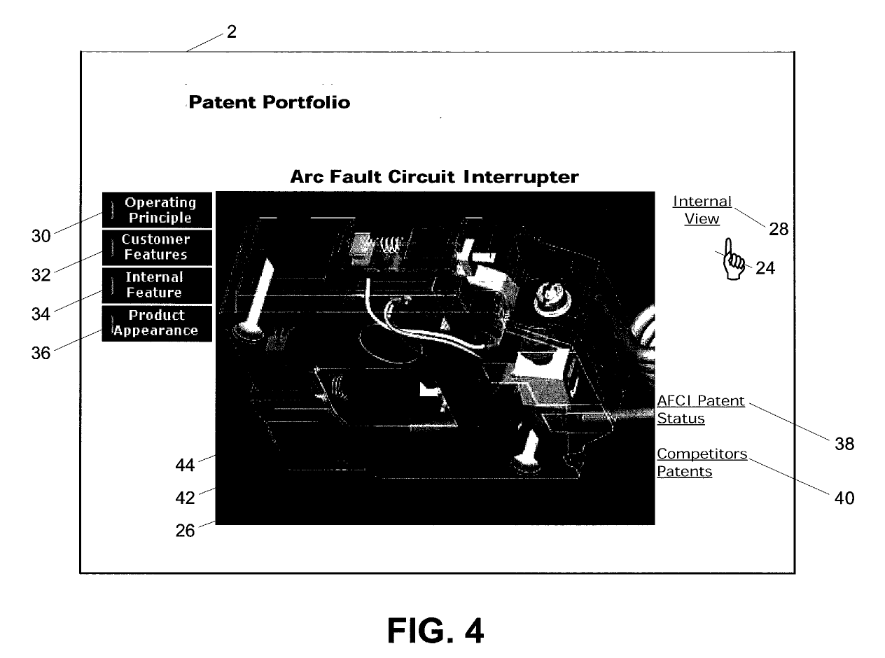

If the graphical representation of the product selected is a CAD drawing, the electronic program may include a number of options for allowing the user to access selective aspects of the category chosen. For example, FIG. 3, which may be the default image display (2), includes buttons germane to an “Internal View” (28) of AFCI picture (26). An internal view may show the components of the AFCI or other features. FIG. 4 shows the internal features by highlighting internal components of AFCI (26) when cursor (24) is placed over “Internal View” (28). As shown, housing (42) of AFCI (26) may become transparent, with only the outlines (44) visible, so that a user may view the internal components of AFCI (26) when curser (24) is placed over “Internal View” (28). “Highlighting” includes designating or distinguishing a portion of a product from the remainder of the product in any way that allows the portion to be easily identified. A “curser” is any item used to identify one link versus another.

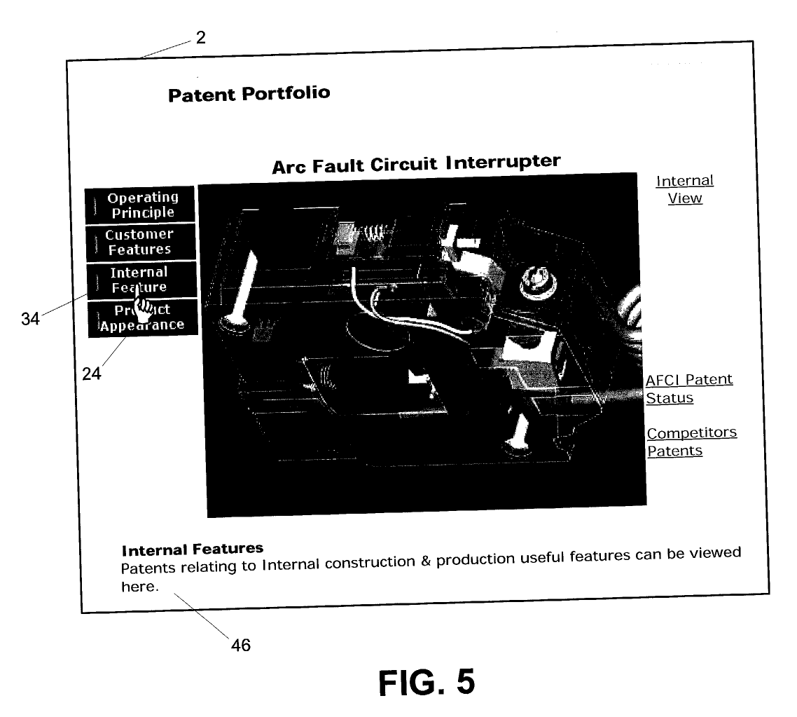

The selection of a category or product such as AFCI (26) also corresponds with the displaying of other buttons and/or links. For example, adjacent to AFCI picture (26) may be information buttons and/or links to “Operation Principle” (30), “Customer Features” (32), “Internal Feature” (34), “Product Appearance” (36), “Patent Status” (38), and “Competitors Patents” (40). Each of buttons (30-40) may include links to information in accordance with their respective titles. For example, as shown in FIG. 5, as a user moves cursor (24) over (in the present aspect not clicking the button) “Internal Feature” (34), the text (46) may appear below AFCI picture (26) to describe what kinds of information will be shown if the user decides to select “Internal Feature” (34) by, for example, clicking on the mouse. Therefore, by moving curser (24) over buttons (30-40), the display (2) changes to show an image relevant to the button the curser (24) is over.

Upon moving the cursor off of a button, the default image (in the present aspect shown as FIG. 3) reappears. Any number of other buttons to change the image of window (2) may be included as desired.

The “Operating Principle” button (30) may include patent and other intellectual property information relating to the operation of the product of interest and the intended uses of the product, among other information. Like the “Internal Feature” button (34), the computer program may cause an altered window (2) image of summary information when curser (24) is over “Operating Principle” button (30), while detailed information on relating to the operating principle may be shown if a user clicks on “Operating Principle” button (30).

The “Customer Features” button (32) may include patent information relevant to features useful to customers for the product of interest. Again, a summary of the customer features may be shown when curser (24) is over the “Customer Features” button (32), while details of the patents and additional information may be displayed by clicking the “Customer Features” button (32).

The “Product Appearance” button (36) may include information on patents or other intellectual property germane to the appearance of the product, such as design patents.

Any number of other buttons may be included to display information that may be useful and related to intellectual property.

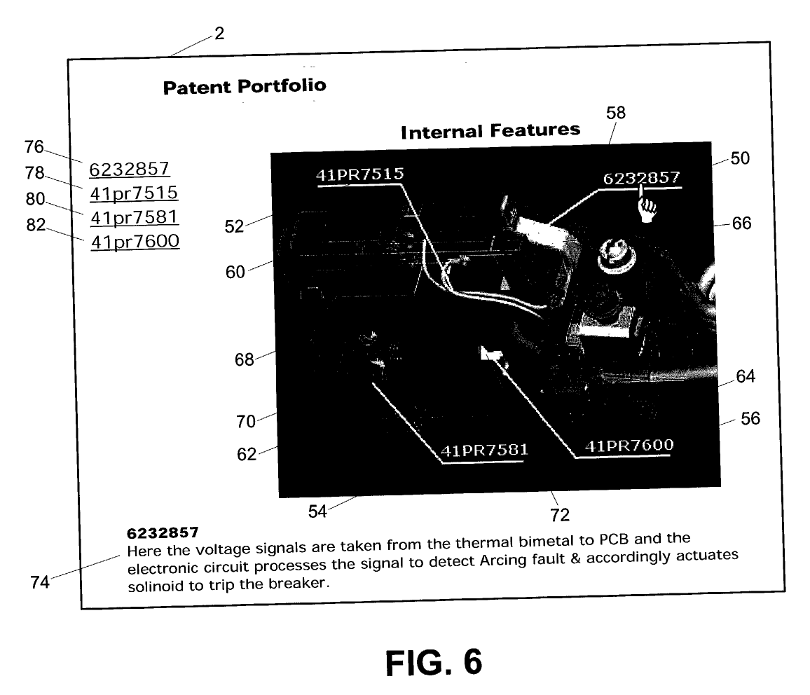

Upon clicking the mouse on one of the buttons described above, window (2) may change with new buttons and/or links to intellectual property data. For example, if “Internal Feature” (34) is clicked, the image of FIG. 6 may be displayed in window (2). According to the aspect of FIG. 6, one or more links to intellectual property data may be displayed for the product, in the present case for AFCI (26). For example, FIG. 6 exhibits links (50, 52, 54, and 56). Each of links (50-56), according to the present aspect, relate to a patent or a patent application. Each link may also include an indicator to indicate what portions of a category or product are related to the intellectual property information. Indicators may include pointers (58, 60, 62, and 64), which are associated with links (50, 52, 54, and 56) respectively. In addition, or alternative to the inclusion of pointers, display (2) may highlight portions of the AFCI (26) (or other product) to indicate what portions of the product are related to the intellectual property links. In the present aspect, portions (66, 68, 70, and 72) are highlighted with their associated links (50, 52, 54, and 56), respectively, to advantageously allow the user to easily ascertain what aspects of the product may have patent protection associated therewith.

Alternatively, a reverse system may be used. That is, a user may in some aspects of the present invention select a patent and link to one or more products, services, technologies, or categories that are part of the company's business.

Returning to the aspect of FIG. 6, as a user moves curser (24) over an intellectual property link or button such as links (50, 52, 54, or 56), window (2) may display a short description of the intellectual property related to the link. For example, as shown in FIG. 6, with cursor (24) over link 50—which in the present aspect is an issued patent link (to U.S. Pat. No. 6,232,857)—a short description (74) of the patented invention in layman's language is displayed. The short description (74) may typically be twenty to thirty words in length, but this is not necessarily so. Any length description can be used.

In contrast to link (50) links (52, 54, and 56) may be labeled with a docket number and thus become patent docketing information links. This may be done if, for example, aspects of the product are associated with a piece of intellectual property that may not have come to maturity at the time of accessing AFCI (26). Links (52, 54, and 56) may include information concerning a variety of intellectual property data, including, but limited to: patents, patent applications, docketing information, design patents, patent status, copyright or trademark registrations, trade secret information, foreign patents, foreign patent docketing information, foreign patent status, competitor's patents, business data such as sales, costs, etc., or any other intellectual property information.

According to one aspect of the invention, the electronic program may cause links 50-56 to access an intellectual property information database and/or docketing system automatically to update the information as it is entered into the system. Further, the links' appearance may be programmed to change from docket numbers to patent numbers automatically upon the issuance of a patent and entry of the number into the database and/or docketing system.

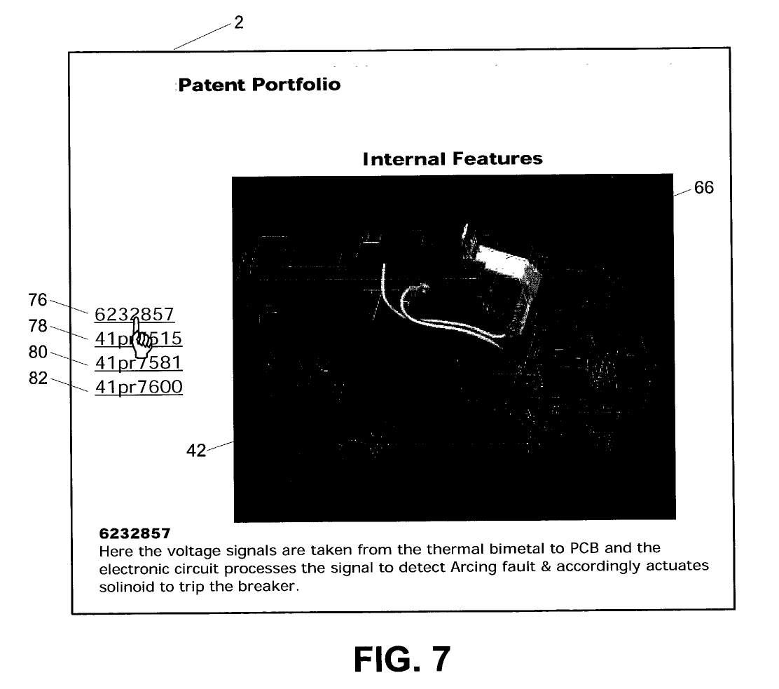

Other buttons may also be added to another portion of the display (2), for example links (76, 78, 80, and 82) may be access data similar to the information found at links (50, 52, 54, and 56), respectively, as shown in FIG. 6. However, upon placing cursor (24) over one of links (76, 78, 80, and 82), the associated portion of the product having an intellectual property component may be separately and advantageously highlighted to the exclusion of the any other components, as shown in FIG. 7 when curser (24) is over link (76). Such a highlighting scheme enables easy introduction to the user of what portions of the product are associated with the designated intellectual property link.

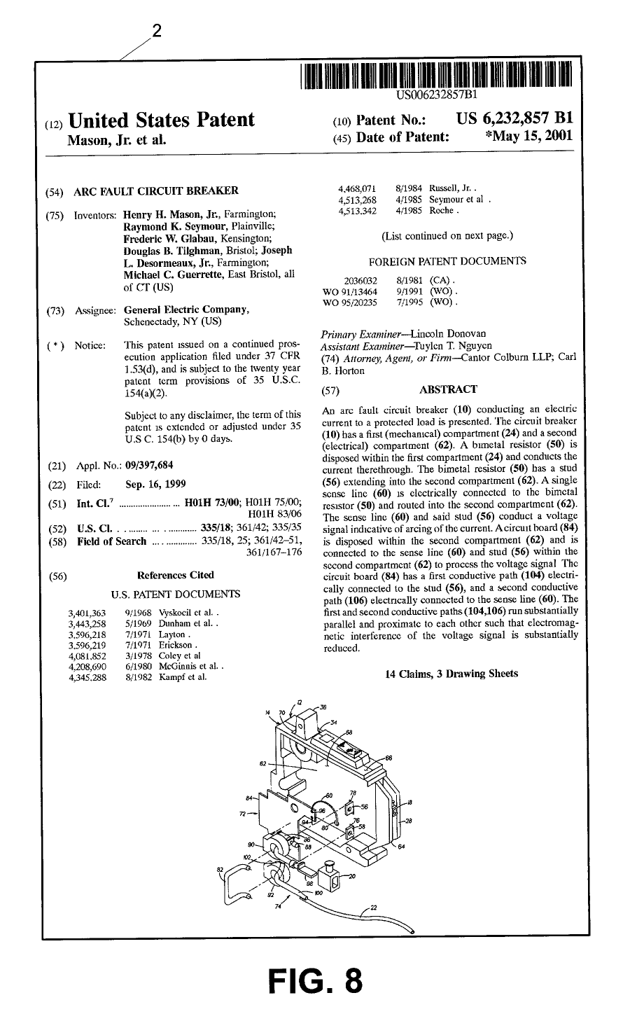

According to one aspect of the present invention, a user may click on an intellectual property link, such as link (50), and the program will link to and display the associated intellectual property documents themselves. For example, if the user clicks on link (50), the user may access the view shown on display (2) of FIG. 8. FIG. 8 displays an electronic copy, for example in .pdf format, of the issued U.S. patent associated with link (50). Links to .pdf files of U.S. patents are readily available from many sources including the USPTO's website at www.uspto.gov. Other web based services for U.S. and foreign patents, publications, and other intellectual property information and documents may also be accessed and such linking capability is within skill of the ordinary artisan having the benefit of this disclosure.

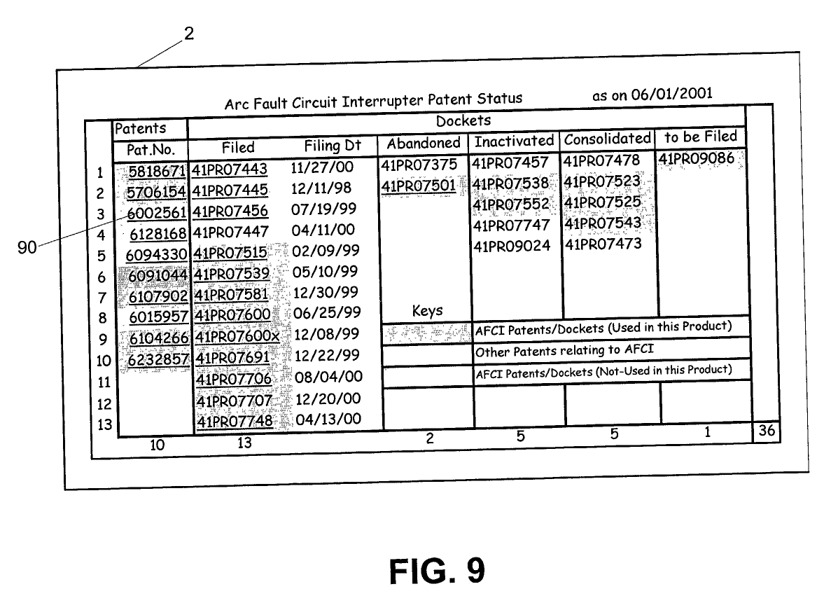

Similarly, a user may click on another link such as link (52), which may cause the program to display other information as shown in FIG. 9. According to the aspect of FIG. 9, intellectual property information relating to AFCI (26) may be displayed in a spreadsheet or tabular format, but this is not necessarily so. The information shown in FIG. 9 may be docket information and patent status information on one or more aspects of AFCI (26). The information may include patent numbers, docket numbers, filing date, status information, and other information as desired and links to the actual document, such as link (90) to a patent. In some aspects, the information presented may be linked and programmed to automatically access and display any new information that may be input to a Docketing System. Docketing Systems are available from a myriad of sources, including, but not limited to, PATTSY, PC Docs, MemoTech, Smart Docket, PC Master, and IPPO.

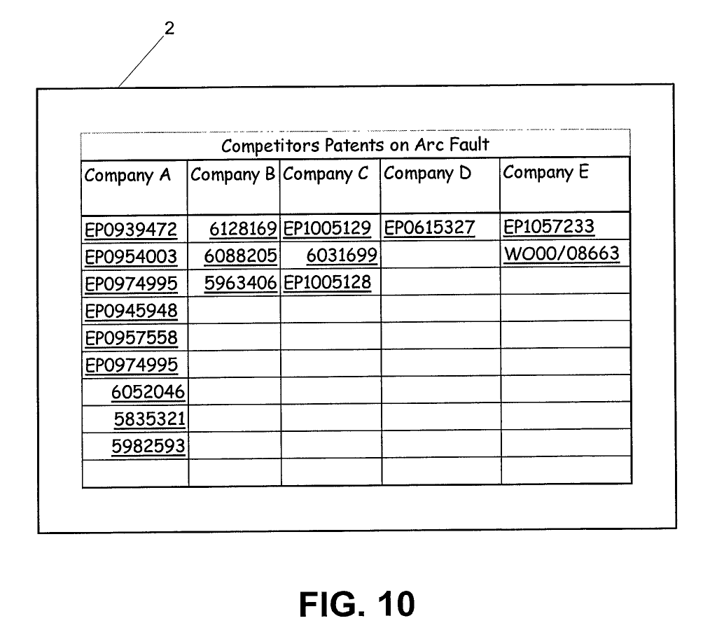

As discussed above with reference to FIG. 4, according to one aspect of the present invention there may be a link (38) to competitor's patents related to the product selected (in the present aspect AFCI (26)). Selecting link (38) by clicking on the link may cause the program to change the display of window (2) with the information shown in FIG. 10. Such information may be presented in spreadsheet or tabular form, or any other form, and may include information such as the competitor companies holding related patents, along with patent numbers, and links to view the actual patents relating to the product at issue.

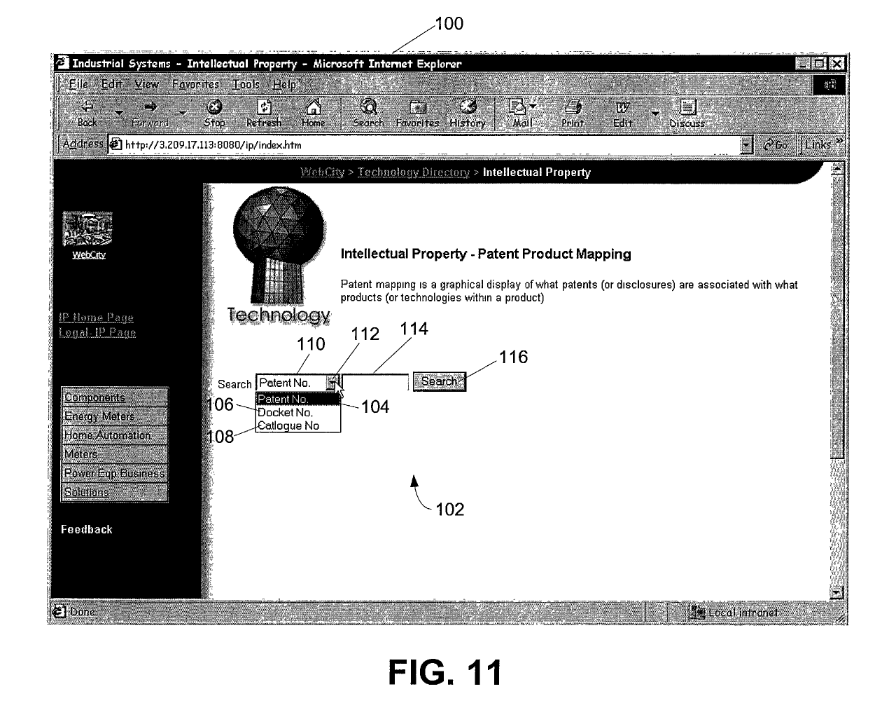

Turning next to FIG. 11, another aspect of the present invention is displayed. According to the display window (100) of FIG. 1, the present invention may facilitate a search facility (102) for reaching an intellectual property product map such as that shown in FIG. 3. Search facility (102) may be web-based as shown, but this is not necessarily so. Search facility (102) may be any computer searchable database, which, in the present embodiment, may direct the user to products and related patent information based on what the user does know.

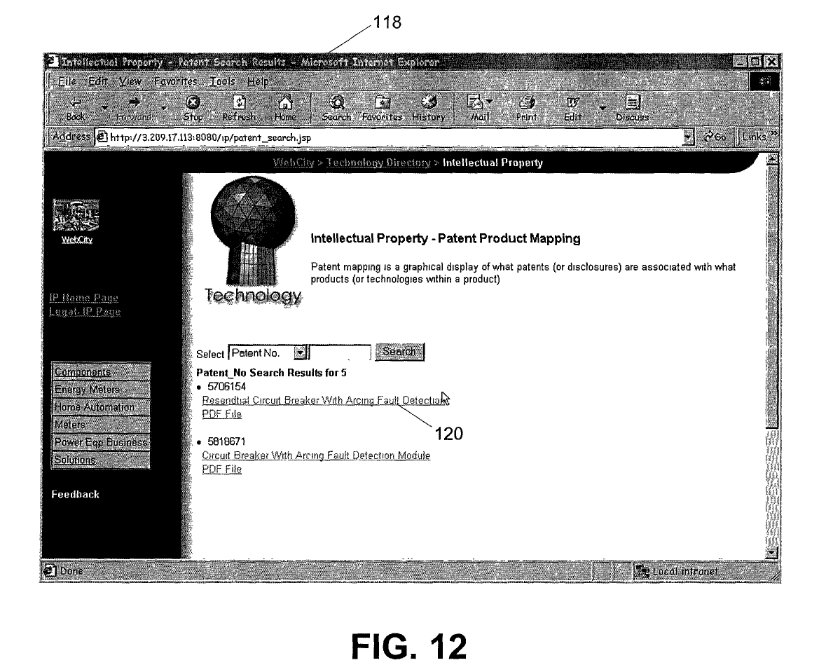

Search facility (102) may include any number of search parameters, including, but not limited to: Pat. No. (104), Docket No. (106), and Catalog No. (108). In the embodiment shown in FIG. 11, a user may know only a patent number, a docket number, a catalog number, or other information and desire to find product and intellectual property related information. A user may interface with display (102) and, for example, know only a certain patent number, or even just a portion of a patent number. The user may select arrow (112) and highlight Pat. No. (104), which is then the selected search parameter displayed in box (110). The user may then enter one or more characters in box (114) with any information she may have. After entering one or more characters in box (114), the user may execute the search by, for example, clicking on “Search” button (116). If, for example, the user entered a “5” into box (114) and executed the search, a new window such as display (118) shown in FIG. 12 may appear.

According to the embodiment of FIG. 12, the completed search for patent numbers containing a “5” yielded two results, displayed as “5706154” and “5818671. ” The patent number search results may show links to patents and to their associated products as shown. In the exemplary embodiment shown as FIG. 12, patent Number 5706154 is associated with a “Residential Circuit Breaker With Arcing Fault Detection” product shown as link (120). If a user elects to click on the link (120), she will be brought to the display of FIG. 3 or another similar display showing the product with links to various intellectual information as described above.

Similarly, a user may enter docketing information, catalog information, or other data and be led to products and their associated intellectual property information.

Search facilities such as that shown in FIGS. 11-12 may be readily programmed or accessed by one of skill in the art having the benefit of this disclosure.

The preceding description has been presented only to illustrate and describe exemplary aspects of the invention. It is not intended to be exhaustive or to limit the invention to any precise form disclosed. Many modifications and variations are possible in light of the above teaching.

The preferred aspect was chosen and described in order to best explain the principles of the invention and its practical application. The preceding description is intended to enable others skilled in the art to best utilize the invention in various aspects and with various modifications as are suited to the particular use contemplated. It is intended that the scope of the invention be defined by the following claims.

What is claimed is:

1. A method of organizing intellectual property data comprising:
providing a graphical representation of an aspect of a product;
providing intellectual property information related to the product;
linking the graphical representation of the aspect of the product to the intellectual property information.

2. The method of claim 1, wherein linking further comprises an indicator associated with a link to the intellectual property information, the indicator identifying which portions of the aspect of the product are associated with the intellectual property information link.

3. The method of claim 2, wherein the indicator comprises highlighting a portion of the graphical representation of the aspect of the product associated with the link to the intellectual property information.

4. The method of claim 3, wherein the highlighting of a portion of the graphical representation of the aspect of the product occurs in response to placing a cursor over the intellectual property information link.

5. The method of claim 3, further comprising highlighting another portion of the graphical representation of the aspect of the product associated with another intellectual property information link.

6. The method of claim 3, wherein non-highlighted portions of the graphical representation of the aspect of the product are transparent.

7. The method of claim 1, wherein the intellectual property information related to the aspect of the product comprises one or more of: patent numbers, patents, patent applications, docketing information, design patent numbers, design patents, patent status, copyright registrations, trade secret information, foreign patent numbers, patent families, and patent family status.

8. The method of claim 1, wherein the link to intellectual property information comprises patent number buttons representing one or more patent numbers corresponding to issued patents.

9. The method of claim 8, wherein a summary of the patent corresponding to the one or more patent number buttons displayed is shown in response to placing a cursor over the one or more patent number buttons.

10. The method of claim 8, wherein the issued patents are displayed in response to clicking on the one or more patent number buttons.

11. The method of claim 1, wherein the linking of intellectual property information comprises displaying one or more docket numbers corresponding to patent applications.

12. The method of claim 11, wherein a summary of the patent application corresponding to the one or more docket numbers displayed is shown in response to placing a cursor over the one or more docket numbers displayed.

13. The method of claim 1, wherein the accessing of the graphical representation of the aspect of the product and the related intellectual property information are accomplished via a connection to an internet or intranet.

14. The method of claim 1, wherein the graphical representation of the aspect of the product is a computer-monitor display of the product's appearance.

15. The method of claim 14, wherein the graphical representation is a three dimensional CAD drawing.

16. The method of claim 14, wherein the graphical representation is a digital photograph.

17. The method of claim 1, where the providing of intellectual property information related to the product further comprises selecting a presentation language of the intellectual property information.

18. An electronic program for organizing intellectual property information, the program, when executed:
displaying a menu of products; and
upon selection of a product, displaying a graphical representation of the selected product, the graphical representation including links identifying portions of the selected product to intellectual property information related to the identified portion of the product.

19. The program of claim 18, further comprising displaying a choice of language selections, wherein a selection of a language causes the program to translate and display text in the selected language.

20. The program of claim 18, wherein the links identifying portions of the selected product to intellectual property information related to the product include links to issued patents.

21. The program of claim 20, wherein the issued patents are patent families.

22. The program of claim 18, where the links identifying portions of the selected product to intellectual property information related to the product include links to patent docketing information.

23. The program of claim 18, wherein the identified portions of the product having related intellectual property information are highlighted.

24. The program of claim 18, wherein the program causes new entries to a docketing program to be automatically retrieved and displayed upon selection of a patent docketing information link.

25. The program of claim 24, wherein the program causes the patent docketing information link to be automatically replaced by a patent number when the associated patent issues.

26. The program of claim 18, further comprising links to competitors' patents relating to the selected product.

27. The program of claim 18, further comprising links to expired patents related to the selected product.

28. The program according to claim 18, stored on a retrievable media.

29. The program according to claim 28, wherein the retrievable media is a disk.

30. The program according to claim 28, wherein the retrievable media is a CD.

31. The program of claim 18, wherein the program is a web-based program compatible with internet and intranet software programs.

32. A method of accessing intellectual property data comprising:
selecting a product from an electronic menu of products;
viewing a graphical representation of the product selected;
placing a cursor at a link on the graphical representation of the product selected, the link being associated with at least a portion of the product and having an indicator to indicate what portion of the product is associated with the link, wherein the link contains intellectual property data; and
viewing the intellectual property data associated with the at least a portion of the product.

33. The method of claim 32, further comprising selecting the link.

34. The method of claim 32, wherein the indicator comprises highlighting the at least one portion of the graphical representation of the product while at least some remaining portions of the graphical representation of product are transparent.

35. The method of claim 32, wherein the intellectual property data associated with the at least a portion of the product comprises a patent, and wherein clicking on the link causes an electronic copy of the patent to be displayed.

36. The method of claim 32, wherein the intellectual property data associated with at least a portion of the product includes one or more of: patent numbers, patents, patent applications, docketing information, design patent numbers, design patents, patent status, copyright registrations, trade secret information, and patent family data.

37. The method of claim 32, further comprising translating text displayed into a selected language.

38. The method of claim 32, wherein the menu is a web-based menu.

39. A system comprising:
a menu of product aspects; and
a link for providing intellectual property data covering any of the menu of products.

40. The system of claim 39, further comprising a display of the product aspects, the display distinguishing between different portions of the product aspects having different intellectual property data related thereto.

41. The system of claim 39, wherein the link is to one or more patents or patent applications.

42. A method of analyzing a product comprising:
viewing a picture of an aspect of the product;
accessing intellectual property data relating to the aspect of the product;
wherein the accessing of intellectual property data is accomplished by selecting a link associating the aspect of the product to the intellectual property data.

43. A method of accessing intellectual property information comprising:
selecting a product from a web-based menu of products;
viewing a graphical representation of the product selected;
placing a cursor over a link on the graphical representation of the product selected, the link pointing to a portion of the product;
wherein the portion of the product is highlighted to indicate an association with the link; and wherein the link contains one or more patents covering the portion of the product.

44. A method of accessing product information comprising:
entering at least a portion of a patent number into a search facility;
searching for the at least a portion of a patent number in a database; and
accessing a graphical representation of products and related intellectual property information associated with the at least a portion of the patent number entered.

45. The method of claim 44 further comprising displaying links to intellectual property information associated with the products found by searching for the at least a portion of the patent number.

46. A method of accessing product information comprising:
entering at least a portion of a patent docket number into a search facility;
searching for the at least a portion of a patent docket number in a database; and
accessing a graphical representation of products and related intellectual property information associated with the at least a portion of the patent docket number entered.

47. A method of accessing product information comprising:
entering at least a portion of a catalog number into a search facility;
searching for the at least a portion of a catalog number in a database; and
accessing a graphical representation of products and related intellectual property information associated with the at least a portion of the catalog number entered.

48. An method of using an electronic program for organizing intellectual property information comprising:
displaying a menu of products; and
upon selecting a product, displaying a graphical representation of the selected product, the graphical representation including links identifying portions of the selected product to intellectual property information related to the identified portion of the product.
